(19) United States
(12) Patent Application Publication
(10) Pub. No.: US 2014/0166177 A1
(43) Pub. Date: Jun. 19, 2014

(54) HIGH CONTRAST TIRE PATTERN

(71) Applicants: Olivier Muhlhoff, Ladoux (FR); Antoine Paturle, Clermont-Ferrand Cedex 9 (FR); Jean-Claude Desvignes, Clermont- Ferrand Cedex 9 (FR)

(72) Inventors: Olivier Muhlhoff, Ladoux (FR); Antoine Paturle, Clermont-Ferrand Cedex 9 (FR); Jean-Claude Desvignes, Clermont- Ferrand Cedex 9 (FR)

(73) Assignee: Compagnie Generale Des Establissements Michelin, Clermont-Ferrand (FR)

(21) Appl. No.: 14/007,702

(22) PCT Filed: Apr. 2, 2012
(86) PCT No.: PCT/EP2012/055946

§ 371 Date: Dec. 9, 2013

(30) Foreign Application Priority Data
May 31, 2011 (FR) 1152753

(51) Int. Cl. B60C 13/00; B29D 30/72

(52) U.S. Cl. CPC B60C 13/001; B29D 30/72
USPC 152/523; 249/187.1

(57) ABSTRACT

A rubber tire comprising a surface having, over at least a portion of this surface, a pattern comprising a plurality of bars placed substantially parallel with one another, each comprising a tip distant from the surface of the tire and a base materially integral with the tire. Each bar of the plurality of bars comprises two inclined walls extending on either side of the tip towards the base, the angle of inclination of each inclined walls less than or equal in absolute value to 25° relative to a direction perpendicular to the surface. The bases of the bars are not in contact with one another so that the bases of two adjacent bars delimit a residual surface between the bars. The width of the residual surface corresponding to a distance between the bases of the two adjacent bars is less than or equal to half the height of the adjacent bars, the height being between 0.1 mm and 0.8 mm.

### BACKGROUND

1. Field

Disclosed herein is a tire for a motor vehicle comprising a pattern with high contrast and a mold for the molding and curing of the said tire.

2. Description of The Related Art

The sidewalls of tires have a large quantity of patterns, also called markings. These patterns are designed on the one hand to give technical and legal information and on the other hand to allow consumers to identify the origin of the product.

There are constant attempts to improve the visibility and legibility of these patterns on the sidewalls of the tires.

Document WO2007/045425 describes a pattern with high contrast comprising a plurality of strands protruding from a tire surface. “Strand” means a filiform element of which the height is at least equal to twice the diameter of a disk with the same surface area as the average section of the strand.

The effect of these strands is to “trap” the incident light rays which meet the surface of the pattern. This makes it possible to give a blacker appearance to the pattern relative to the rest of the sidewall of the tire. The strands make it possible to obtain also a particularly pleasant feel, of the “velvet” type.

However, a pattern comprising such strands may be less resistant to certain mechanical attacks which the tire may sustain during its use.

In order to improve the mechanical strength of the pattern, it has been proposed to use bars in place of strands. The bars are elongate strands having a length at least equal to twice their height. These bars are molded by striations formed in a mold designed to mold and cure the tire comprising the pattern. The production of striations in a mold takes more time overall than the production of holes for molding strands. For the purpose of improving the time for producing these striations, it has been envisaged to reduce the number of bars in the pattern and to increase the spacing between these bars. The pattern then has residual surfaces between the bases of the bars. These residual surfaces have a surface state that is smooth and shiny when compared with the surface state of the sidewall of the tire. If the residual surfaces have dimensions that are too large, incident light rays meeting these residual surfaces can be directly returned to the outside of the pattern to an observer without being trapped by the pattern. Depending on the direction of the light rays returned by the residual surfaces and on the position of the observer relative to the tire, the pattern may then present differences of contrast with the rest of the sidewall of the tire and therefore in certain cases have inferior visibility.

SUMMARY

The tire and mold described herein result from the application of particular design rules for the production of a pattern with high contrast comprising bars, therefore making it possible to optimize the time for machining a mold molding the said pattern, while maintaining a great quality of contrast of the pattern with the rest of the surface of a sidewall of a tire irrespective of the position of the observer with respect to this tire.

### DEFINITIONS

“Rubber” means a diene elastomer, that is to say in a known manner an elastomer originating at least in part from (that is to say homopolymer or a copolymer) diene monomers (monomers carrying two double carbon-carbon links which may or may not be bonded).

“Tire” means all types of elastic bandings which may or may not be subjected to an internal pressure.

“Mold” means a set of separate elements which, by being brought together, make it possible to delimit a toroidal molding space.

“Molding surface of a mold” means the internal surface of the mold delimiting the toroidal molding space. This internal surface comprises a bottom and portions protruding on the said bottom forming beads. The bottom of the internal surface is designed to mold the running surface of the tire and the beads are designed to mold grooves in the tread.

“Incident light ray” means a light ray arriving on a surface.

“Reflected light ray” means a light ray returned by a surface.

“Radial direction” means any direction perpendicular to the rotation axis of the tire.

Disclosed herein is a rubber tire comprising a surface having, over at least a portion of this surface, a pattern comprising a plurality of bars placed substantially parallel with one another, each bar of the plurality of bars comprising a tip distant from the surface of the tire and a base made materially integral with the said tire. Each bar of the plurality of bars comprises two inclined walls extending on either side of the tip of the bar towards the base of the said bar, the angle of inclination of each of the said inclined walls being less than or equal in absolute value to 25° relative to a direction perpendicular to the surface of the tire. The bases of the bars are not in contact with one another so that the bases of two adjacent bars delimit a residual surface between the said bars. The width of the residual surface corresponding to a distance between the bases of the two adjacent bars is less than or equal to half the height of the said adjacent bars, the said height being between 0.1 mm and 0.8 mm.

The bars therefore have a height that is much greater than the width of the residual surfaces. These bars therefore have a great capacity to divert the incident light rays before the latter touch the residual surfaces of the pattern, and more particularly to divert the light rays having an angle of incidence greater than 20° with a direction perpendicular to a surface of the tire comprising the pattern. This limits the quantity of light received by the residual surfaces of the pattern.

Each time an incident light ray meets a bar on a wall of this bar, the latter is reflected by the said wall. The direction of reflection of the light ray depends on the direction of the incident light ray and on the angle of inclination of the wall. Thus, depending on the direction of the incident light ray and on the angle of inclination of the wall, the light ray may be returned to a wall of an adjacent bar or the light ray may be returned to the outside of the pattern directly to an observer. In the first case, the light ray “is lost” in the pattern and will no longer be perceptible to the eye of an observer. In the second case, the observer can perceive the light ray and the pattern can then appear to be brighter. The inclination of the walls as defined in the invention therefore makes it possible to ensure that a large portion of the light rays meeting a wall of a bar is returned to at least one other wall of an adjacent bar.

By virtue of the arrangement and size of the bars, the contrast of the pattern with the rest of the surface of the sidewall of the tire is improved irrespective of the position of the observer with respect to the tire.

In a variant embodiment, the width of the residual surface is less than or equal to a third of the height of the adjacent bars.

This further improves the capacity of the bars to divert the incident light rays before the latter touch the residual surfaces of the pattern, and more particularly to divert the light rays having an angle of incidence greater than 10° with a direction perpendicular to the surface of the tire comprising the pattern.

In a variant embodiment, the mean roughness of the residual surface is between 5 μm and 30 μm.

With such roughness, when an incident light ray reaches the residual surface, the latter is diverted in a random manner and may therefore be more easily returned to a wall of a bar in order to be “lost” in the pattern. Thus, if a light ray has an angle of incidence close to 0° C. with the surface of the tire comprising the pattern, the probability that this light ray is returned directly in this perpendicular direction is slight. This limits the capacity of the residual surface to directly return incident light rays.

In a variant embodiment, the tip of each bar has a rounded shape having, according to a sectional view, a medium radius of between 0.005 mm and 0.05 mm.

This improves the mechanical strength of the tip of the bar while limiting the capacity of the tip to directly return incident light rays.

In a variant embodiment, the tip of each bar comprises a plurality of peaks and hollows in the length of the said bar.

The tip of the bar therefore has an uneven appearance in the length of the bar. This then makes the reflection of the incident light rays by the tip of the bar yet more arbitrary.

In a variant embodiment, the tips of the bars are extended in height by strands made materially integral with the said bars, each strand having an average section of between 0.003 and 0.06 mm² and the density of the strands in the pattern is at least equal to five strands per unit of surface area expressed in square millimetres (mm²).

Advantageously this associates the particularly pleasant feel of the strands with the mechanical strength of the bars.

In a variant embodiment, the pattern is present on a sidewall of the tire and the bars of the said pattern are oriented in a radial direction on the said sidewall.

Such an orientation of the bars ensures that the pattern will be more resistant to certain mechanical attacks, such as the attacks caused by rubbing against footpaths.

In a variant embodiment, the residual surface is domed.

This promotes the reflection of the incident light rays towards inclined walls of the bars of the pattern.

Another subject of the invention is a mold comprising striations for the molding of bars of a pattern as described above.

### BRIEF DESCRIPTION OF THE DRAWINGS

Other features and advantages of the invention will emerge from the following description, given as an example, with no limiting character, with respect to the appended drawings in which:

FIG. 1 represents schematically a view in perspective of a pattern comprising bars according to a first embodiment of the invention;

FIG. 2 illustrates the method of calculating the mean roughness used to determine the roughness of the bottom of a groove separating two bars of FIG. 1;

FIG. 3 represents schematically a view in perspective of a pattern comprising bars and strands according to a second embodiment of the invention;

FIG. 4 represents schematically a view in perspective of a pattern comprising bars according to a third embodiment of the invention.

### DETAILED DESCRIPTION OF SPECIFIC EMBODIMENTS

In the following description, elements that are substantially identical or similar will be indicated by identical references.

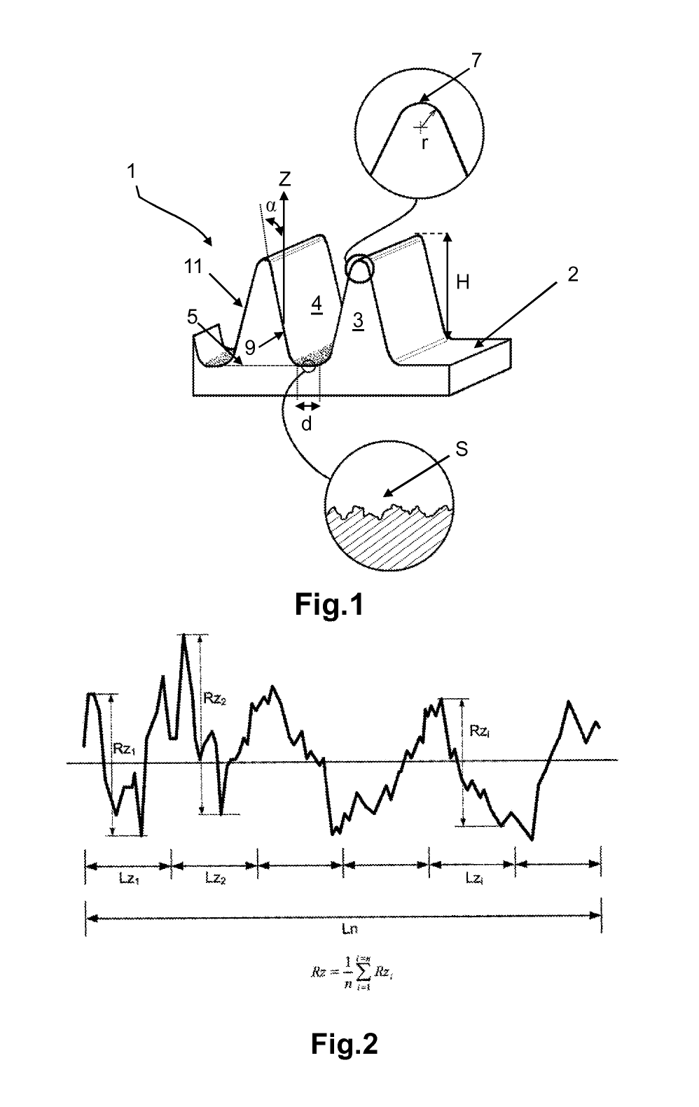

FIG. 1 represents schematically a view in perspective of a pattern 1 according to the invention.

The pattern 1 comprises bars 3 separated by grooves 4.

Each bar may in this instance be divided into three layers: a tip layer, a base layer, and an intermediate layer placed between the tip layer and the base layer.

The tip layer is delimited by a curved surface with an average radius r of between 0.005 mm and 0.05 mm. The tip 7 of the bar corresponds to all of the highest points of the tip layer taken in the length of the bar.

The intermediate layer is delimited by two rectilinear inclined walls which extend in the length of the bar. The angle of inclination a of the inclined walls is in this instance less than or equal in absolute value to 25° relative to a direction Z perpendicular to the surface 2 of the tire comprising the pattern 1.

The base layer is delimited by two curvilinear surfaces providing the junction between the inclined walls of the intermediate layer and a residual surface S that is present between two adjacent bars. The residual surface is in this instance generally flat and is situated at the same level as the surface 2 of the tire. As a variant, the residual surface may be higher or lower than this surface 2.

The base 5 of the bar corresponds to the bottom portion of the base layer, that is to say to all the points of the base layer that are situated at the same level as the residual surface S. The width of the base 5 of the bar is in this instance less than or equal to 0.5 mm.

It is possible to determine a height H of the bar. This height H corresponds to the distance between the tip 7 of the bar and the base 5 of the bar and in this instance is between 0.1 mm and 0.8 mm.

The residual surface between the two adjacent bars forms the bottom of the groove 4. The width of this residual surface, that is to say the distance d between the bases of the two adjacent bars is in this instance less than or equal to half the height H of the bars.

As a variant, the distance d is less than or equal to a third of the height of the adjacent bars.

It will be noted that, if the adjacent bars have different heights, the lowest height is selected to determine the distance d.

The bars are in this instance placed substantially parallel with one another. “Parallel bars” means that there may be a slight angle between two bars of the pattern, for example an angle of between 0 and 5°.

With this arrangement of bars 3, any incident light ray coming into contact with an inclined wall will be reflected towards another inclined wall of the pattern and will therefore “be lost” in the pattern. Specifically, each time a light ray comes into contact with a wall, it loses intensity. It is estimated that, after two contacts with walls of the pattern, the light ray is no longer perceptible to the eye of an observer. Therefore “being lost in the pattern” means that the light ray can be returned to the outside of the pattern but that its light intensity will be so weak that it will not be able to be perceived by the eye of an observer. This promotes the obtaining of a black and matt pattern contrasting with the surface 2 of the tire which is smooth and shiny.

The residual surface in this instance has an uneven surface state according to the inset situated in the bottom portion of FIG. 1. More particularly, the residual surface has a mean roughness Rz of between 5 μm and 30 μm. In this way, a large portion of the incident light rays arriving on the residual surface will be returned towards an inclined wall of a bar.

In order to determine the mean roughness Rz of the residual surface, a given length of this surface, called the evaluation length Ln, is cut off in n lengths of bases Lz of identical lengths as illustrated in FIG. 2. On each of the base lengths, an individual profile height Rzi is determined which is the largest total of the protrusion heights and the greatest depths of hollows of the profile of the residual surface within the base length Lzi. The average height Rz is the arithmetic average of the individual values Rzi over all of the base lengths in question (standard DIN 4768; 1990), and is expressed by the following formula:

$$Rz = \frac{1}{n} {\sum }_{i = 1}^{i = n} {Rz}_{i}$$

In a variant embodiment, it is possible that the walls of the bars and/or the tips of the bars also have a roughness Rz of between 5 μm and 30 μm.

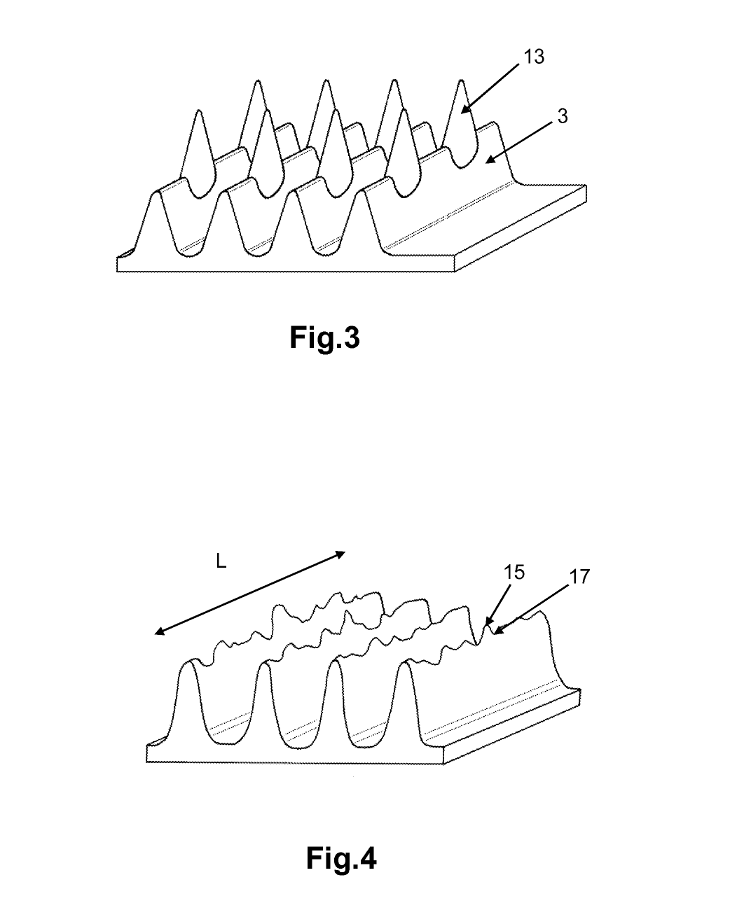

FIG. 3 shows a variant embodiment in which the pattern 1 comprises bars 3 and strands 13. The strands 13 have a section which reduces from the base of the strand to the end of the strand.

More particularly, in the embodiment of FIG. 3, the strands 13 are made materially integral with the tips of the bars 3, that is to say that the strands extend the pattern in height. This improves the capacity of light absorption by the pattern relative to a pattern that comprises only strands as in the prior art, because the strands of the pattern of FIG. 3 are raised relative to the surface of the tire.

In this instance the strands have an average section of between 0.003 and 0.06 mm² and their height is also between 0.1 mm and 0.8 mm.

FIG. 4 shows another variant embodiment in which the tip of each bar comprises a plurality of peaks 15 and hollows 17 in the length L of the bar. The tip of the bar therefore has an uneven appearance. In the particular case shown in this FIG. 4, the height of the bar in this instance corresponds to an average of the heights of the peaks and of the hollows determined in the length of the bar.

The pattern of the invention may be formed on the sidewall of a tire. In this case, it is preferable to orient the bars in a radial direction so as to limit the effects of rubbing when the tire comes into contact with the edge of a pavement. In a variant embodiment, it is possible to form the pattern on the tread of the tire.

The invention also relates to a mold for molding and curing a tire comprising a pattern according to the invention. The mold comprises over a portion of its internal surface a plurality of cavities having the shape of striations. These striations make it possible to mold the bars of the pattern. In the same way, the mold may comprise a plurality of holes for molding the strands of FIG. 3.

The striations in this instance are produced with the aid of a laser by successive passes, each pass having the effect of eroding the metal of the mold over a given surface area and given depth. As an example, a pulsed laser from IPG having a power of 50 W is used to form the striations in the mold.

The invention is not limited to the examples described and shown and various modifications can be made thereto without departing from its context.

In particular, FIG. 1 shows a residual surface S that is generally flat. As a variant, it is possible to provide domed residual surfaces promoting the reflection of the incident light rays towards the inclined walls of the bars of the pattern.

1. A rubber tire comprising:
a surface comprising, over at least a portion thereof:
a pattern comprising,
a plurality of bars placed substantially parallel with one another, each bar of the plurality of bars comprising:
a tip distant from the surface of the tire;
a base made materially integral with said tire;
two inclined walls extending on either side of the tip of said bar towards the base of the said bar;
wherein:
an angle of inclination (α) of each of said inclined walls is less than or equal in absolute value to 25° relative to a direction (Z) perpendicular to the surface of the tire;
the bases of the bars are not in contact with one another, so that the bases of two adjacent bars delimit a residual surface (S) between said bars;
a width of the residual surface corresponds to a distance (d) between the bases of the two adjacent bars that is less than or equal to half the height of the said adjacent bars;
said height being between 0.1 mm and 0.8 mm.

2. The tire according to claim 1, wherein the width of the residual surface is less than or equal to a third of the height of the adjacent bars.

3. The tire according to claim 1, wherein the mean roughness Rz of the residual surface is between 5 μm and 30 μm.

4. The tire according to claim 1, wherein the tip of each bar has a rounded shape having, according to a sectional view, a medium radius of between 0.005 mm and 0.05 mm.

5. The tire according to claim 1, wherein the tip of each bar comprises a plurality of peaks and hollows along the length of said bar.

6. The tire according to claim 1, wherein the pattern further comprises strands that extend in height and are materially integral with said bars, each strand having an average section of between 0.003 and 0.06 mm², and wherein the strands have a density in the pattern that is at least equal to five strands per unit of surface area expressed in square millimetres (mm²).

7. The tire according to claim 1, wherein the surface comprises a sidewall of the tire, and wherein the pattern is present on the sidewall, and wherein the bars of said pattern are oriented in a radial direction on said sidewall.

8. The tire according to claim 1, wherein the residual surface (S) is domed.

9. A mold for the molding and the curing of a tire, comprising striations for the molding of bars belonging to a pattern of a tire according to claim 1.
